(19) United States
(12) Patent Application Publication
(10) Pub. No.: US 2005/0066151 A1
(43) Pub. Date: Mar. 24, 2005

(54) Method and apparatus for handling predicated instructions in an out-of-order processor

(76) Inventor: Sailesh Kottapalli, San Jose, CA (US)

Correspondence Address: Dennis A. Nicholls;BLAKELY, SOKOLOFF, TAYLOR & ZAFMAN LLP, Seventh Floor, 12400 Wilshire Boulevard, Los Angeles, CA, 90025-1030, US

(21) Appl. No.: 10/666,343

(22) Filed: Sep. 19, 2003

(51) Int. Cl. G06F 9/30

(52) U.S. Cl. 712/226

(57) ABSTRACT

A method and apparatus for permitting out-of-order execution of predicated instructions is disclosed. In one embodiment, a predicated instruction may be decoded into a related predicated instruction and a move instruction contingent on the complementary value of the predicate of the predicated instruction. The destination register of both the related predicated instruction and the move instruction may be mapped to the same physical register, and only one of the two instructions may update machine state with its results.

### FIELD

The present disclosure relates generally to microprocessors, and more specifically to microprocessors with predicated instructions in an out-of-order execution environment.

### BACKGROUND

Modem microprocessors often use predication of instructions in their architectures. Predication is a method that may convert control flow dependencies to data dependencies. In general, a predicated instruction is guarded by a single-bit “predicate” that controls the execution of the instruction. The instruction is allowed to commit its semantic results and update the machine state only if the predicate is true. Otherwise, the instruction is “squashed” if the predicate is false. (Here the term squashed means that the machine state will not be updated with the results of the instruction, and in some circumstances the squashed instruction may be diverted from execution at all.) In order to avoid branch-misprediction penalties, the compiler schedules both sides of the branch streams using complementary predicates. Depending on the run-time resolution of the predicate, only one side of the branch stream is executed. In general, most instruction set architectures (ISA) support some predicated instructions. In some cases, such as the Itanium Processor Family (IPF) architecture produced by Intel® Corporation, the ISA is a fully predicated architecture. In these last cases, almost all instructions are guarded by predicates.

Microprocessors capable of Out-Of-Order (OOO) execution, unlike In-Order microprocessors, allow instructions to be executed based on dynamic data-flow requirements rather than the compile time order of the instruction. OOO microprocessors fetch instruction according to program order, execute the individual instruction in an order enforced by the data-flow requirements, and then commit the semantic effects (updating the machine state) in the program order. Among other benefits, OOO microprocessors achieve higher performance by removing name-space collisions (anti-dependencies) and write-after-write (WAW) hazards. This is achieved by renaming all instruction targets (architectural destination registers) into a large pool of physical registers. Each the following uses (e.g. reads) of the same architectural register may then be mapped to the same physical register.

Predicated instructions pose a problem in the design of an OOO microprocessor. Predicated instructions need the ability of retaining the old architectural state for subsequent use when the predicate value is determined to be false. In an OOO microprocessor, this may require that we be able to conditionally execute the instruction or copy the contents of the old physical register mapping to a new physical register mapping.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of portions of a pipeline of a processor, according to one embodiment.

FIG. 2 is a schematic diagram of portions of a pipeline of a processor including a trace cache, according to one embodiment.

FIG. 3 is a flowchart of a method of executing a predicated instruction in an out-of-order processor, according to one embodiment of the present disclosure.

FIGS. 4A and 4B are schematic diagrams of microprocessor systems, according to one embodiment of the present disclosure.

### DETAILED DESCRIPTION

The following description describes techniques for a processor using predication to permit out-of-order (OOO) execution of instructions. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of an Itanium® Processor Family (IPF) processor or in a Pentium® family processor such as those produced by Intel® Corporation. However, the invention may be practiced in kinds of processors that wish to use predication in an out-of-order processing environment.

For the purpose of clarity in this disclosure, certain terminology conventions will be used. Processors may use register renaming, which may map logical registers (those explicitly stated in instructions) to physical registers (actual hardware registers). It may be noted that a processor may have many more physical registers than the total number of logical registers to enhance performance. For example, the Itanium® Processor Family has 128 general registers numbered Gr0 through Gr127, and 64 predicate registers numbered Pr0 through Pr63. But in a given processor there may be many more physical registers of each type. To provide for generality, the present disclosure will use rX to represent the X'th logical register, pX to represent the X'th logical predicate register, rpX to represent the X'th physical register, and ppX to represent the Xth physical predicate register.

Utilizing this notational convention, a generic “do” instruction could be written as
(p10) do r10=r20, r30
   where p10 is the logical predicate register, r10 is the logical destination register, and r20 and r30 are the logical source operand registers. Here the generic “do” instruction may be an integer instruction, a floating-point instruction, a logical instruction, or any other kind of instruction. After the register renaming is performed and the corresponding physical registers are allocated, this instruction may be expressed as
(pp40) do rp50=rp60, rp70
   where pp40 is the physical predicate register, rp50 is the physically destination register, and rp60 and rp70 are the physical source registers.

Predicated instructions may pose a problem in the design of an OOO microprocessor. Predicated instructions need the ability of retaining the old architectural state for subsequent use when the predicate value is determined to be false. In an OOO microprocessor, this may require that we be able to conditionally execute the instruction or copy the contents of the old physical register mapping to a new physical register mapping.

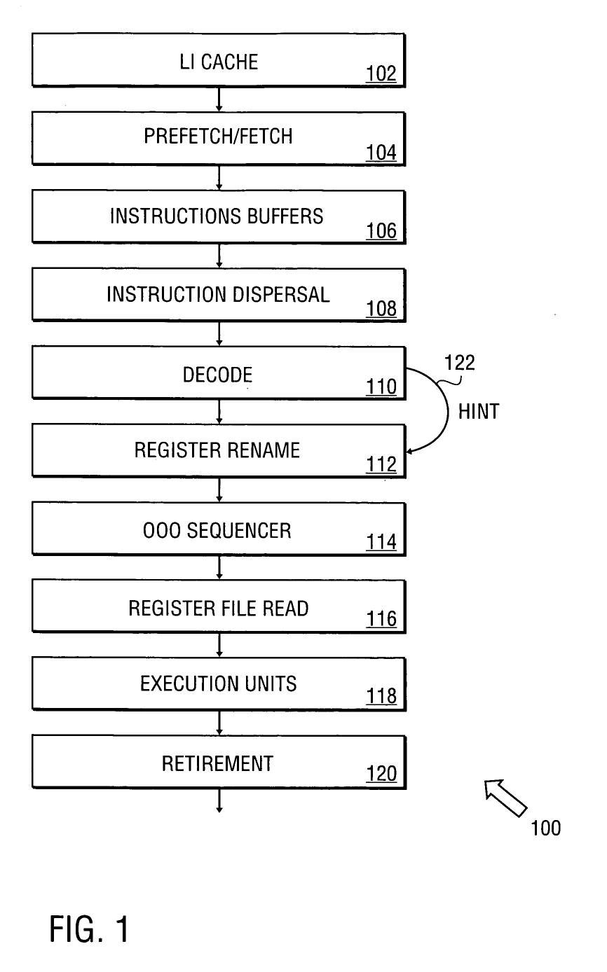

Referring now to FIG. 1, a schematic diagram of portions of a pipeline 100 of a processor are shown, according to one embodiment. Instructions may be fetched or prefetched from a level one (L1) cache 102 by a prefetch/fetch stage 104. These instructions may be temporarily kept in one or more instruction buffers 106 before being sent on down the pipeline by an instruction dispersal stage 108.

A decode stage 110 may take an instruction from a program and produce one or more machine instructions. In one embodiment, the decode stage 110 may take a generic “do” instruction
(p10) do r10=r20, r20
   and decode it into a complementary-predicated pair of machine instructions
cmov.inv r10=r10, p10
do r10=r20, r30, p10
   where the cmov.inv machine instruction (conditional move, inverted predicate value) may move the contents of r10 to r10 when the predicate value in p10 is false. Here the cmove.inv machine instruction responds to the complement of the predicate value in p10. It may be noticed that having the same destination register r10 in two machine instructions could generally cause problems, but in this embodiment the two machine instructions, responding to complementary values of a single predicate, cannot both retire and update state. By decoding the instruction into the two machine instructions in this manner, it may be guaranteed that one and only one of the two machine instructions will in fact retire and update the state. Either the generic “do” machine instruction will update r10 with its calculated value, or the existing value will be moved back into r10 by the cmov.inv machine instruction. And this decoding may make it possible for the two machine instructions to be executed out of order or in parallel.

After exiting the decode stage 110, the instructions may enter the register rename stage 112, where instructions may have their logical registers mapped over to actual physical registers prior to execution. IN the case of the two machine instructions previously discussed
cmov.inv r10=r10, p10
do r10=r20, r30, p10
   the results of the register renaming process may be something like
cmov.inv rp70=rp30, pp30
do rp70=rp90, rp80, pp30
   Again it may be noticed that having the same destination register rp70 in two machine instructions could generally cause problems, but in this embodiment the two machine instructions, responding to complementary values of a single predicate pp30, cannot both retire and update state. By continuing with the decoding of the instruction into the two machine instructions in this manner, it may be guaranteed that one and only one of the two machine instructions will in fact retire and update the state of the physical destination register rp70.

In general, a register rename stage, such as register rename stage 112, may implement rules that prohibit renaming several instances of logical destination registers to a single physical destination register. However, in one embodiment register rename stage 112 may accept a hardware hint signal 122 from the decode stage 110. When the decode stage 110 decodes the original instruction into the pair of machine instructions that respond to complementary values of a predicate, it may issue a hardware hint signal 122 to permit the otherwise impermissible renaming of several instances of logical destination registers to a single physical destination register. In other embodiments, the hint signal may be a software hint signal.

Upon leaving the register renaming stage 112, the machine instructions may enter an OOO sequencer 114. The OOO sequencer 114 may schedule the various machine instructions for execution based upon the availability of data in various source registers. Those instructions whose source registers are waiting for data may have their execution postponed, whereas other instructions whose source registers have their data available may have their execution advanced in order. Consider again the pair of machine instructions
cmov.inv rp70=rp30, pp30
do rp70=rp90, rp80, pp30
   The source registers of these machine instructions are disjoint: one has rp30 and the other has rp90 and rp80. Therefore in differing circumstances one machine instruction may be ready for execution before the other instruction. This may permit their OOO scheduling for execution. In some embodiments, they may be scheduled for execution in parallel.

Upon leaving the OOO sequencer 114, the physical source registers may be read in register read file stage 116 prior to the machine instructions entering one or more execution units 118. After execution in execution units 118, the machine instructions may in a retirement stage 120 update the machine state and write to the physical destination registers depending upon the resolved state of the corresponding predicate values. For our example,
cmov.inv rp70=rp30, pp30
do rp70=rp90, rp80, pp30
   one or the other but not both may update the state of the physical destination register rp70 depending upon whether pp30 is true or false. If true, then rp70 may be updated with the results of the “do” instruction. If false, then rp70 may be updated with the contents of rp30. It may be noted that any dependent of rp70 may need only wait for the resolution of the instruction that will in fact update rp70: it may not be necessary to wait for the resolution of the other instruction and that instruction may be squashed early.

It may be noted that in some embodiments the retirement stage 120 may not need wait for both machine instructions to complete before updating state with the results of the machine instruction that has executed if the resolved predicate value indicates that instruction will in fact be permitted to update state. Taking another example, a load instruction Id, this may enter the decode stage 110 as
(p20) Id r25=[r35]
   This may be decoded into
cmov.inv r25=r25, p20
Id r25=[r35], p20
   which upon register renaming may become
cmov.inv rp55=rp65, pp40
Id rp55=[rp75], pp40
   The load instruction Id may take considerable time both in waiting for data in rp75 but even more so in execution if the cache line containing [rp75] is resolved after pp40 is resolved. But in some embodiments, retirement stage 120 may update the state from the cmov.inv machine instruction if the predicate value in pp40 is false. If so, then there is no need to wait for the Id machine instruction to complete and it may be predicated-off early. In some embodiments, it may be predicated-off and avoid using resources such as execution units 118.

The pipeline stages shown in FIG. 1 are for the purpose of discussion only, and may vary in both function and sequence in various processor pipeline embodiments.

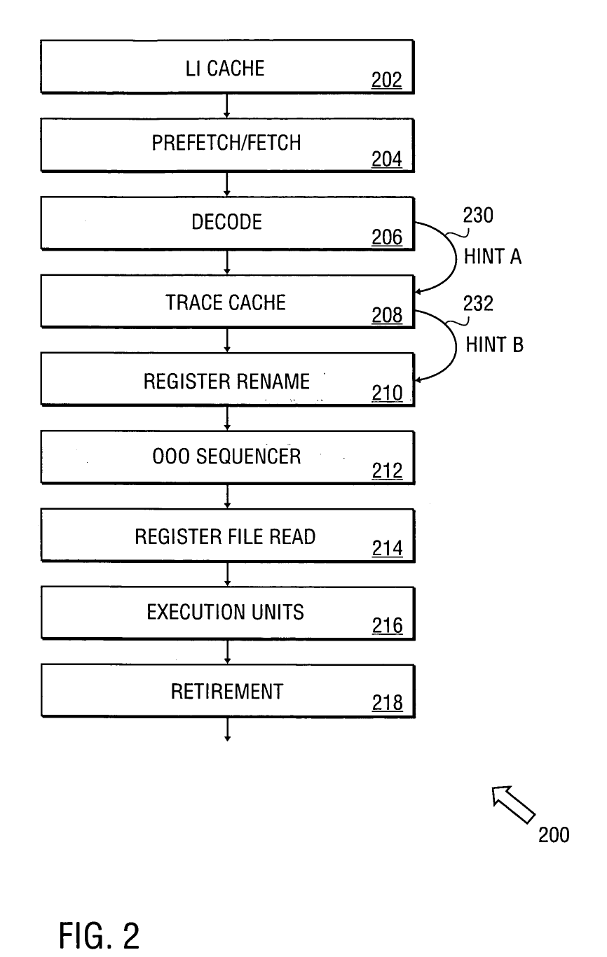

Referring now to FIG. 2, a schematic diagram of portions of a pipeline 200 of a processor including a trace cache 208 is shown, according to one embodiment. The process described in connection with FIG. 1 above may be used in pipeline shown in FIG. 2 with one modification. The trace cache 208 may replace the instruction buffers 106 or other forms of level zero caches in some processor designs. In the trace cache, a collection of machine instructions called a trace is stored in a trace cache 208 subsequent to the process of decoding in a decode stage 206. In the example from FIG. 1,
cmov.inv r10=r10, p10
do r10=r20, r30, p10
   the two machine instructions may be stored together as a trace in trace cache 208.

Because the machine instructions are no longer passed directly from decode stage 206 to the register rename stage 210, the hint to the register rename stage 210 to permit the renaming of both instances of r10 to the same physical register may be passed in two stages: hint A 230 and hint B 232. The hint may be stored in logic within trace cache 208 to permit multiple uses of the trace.

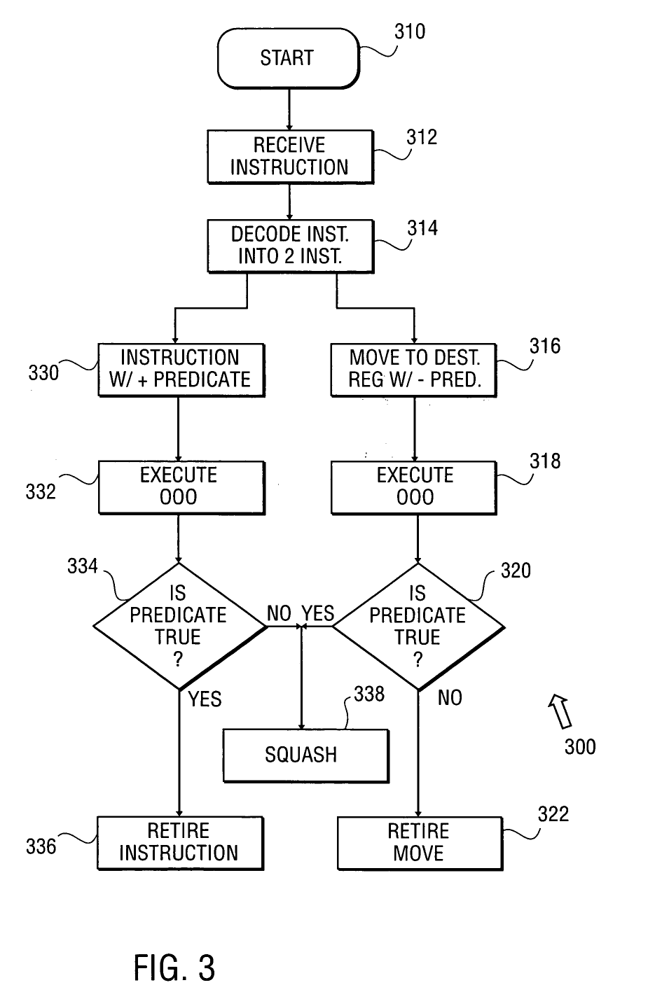

Referring now to FIG. 3, a flowchart of a method of executing a predicated instruction in an out-of-order processor is shown, according to one embodiment of the present disclosure. The process 300 may begin at start block 310 and then the predicated instruction under consideration may be received from cache at block 312. In block 314 the decode stage may decode the predicated instruction into two machine instructions that respond to complementary values of the predicate.

From block 314 onwards, the two machine instructions may be register renamed, sequenced, and executed without regard for one another's progress. In block 330, the machine instruction corresponding to the original predicated instruction may be prepared for execution. This preparation may include register renaming, OOO sequencing, including parallel sequencing if permitted, and physical source register data reading. Then the instruction may be executed in block 332.

Similarly, in block 316 the conditional move machine instruction may be prepared for execution. This preparation may include register renaming, OOO sequencing, including parallel sequencing if permitted, and physical source register data reading. Then the instruction may be executed in block 318.

When the predicate value is finally determined, then in decision blocks 334 and 320 the decisions about which instruction to retire and update state may be made. In decision block 334, if the predicate is true, then the process exits decision block 334 via the YES path and the machine instruction corresponding to the original predicated instruction may be retired in block 336. Otherwise the process exits decision block 334 via the NO path and the instruction is squashed in block 338. Similarly, in decision block 320, if the predicate is false (not true); then the process exits decision block 320 via the NO path and the conditional move machine instruction may be retired in block 322. Otherwise the process exits decision block 320 via the YES path and the instruction is squashed in block 338.

In other embodiments, the process shown in FIG. 3 may incorporate different logical blocks occurring in varying orders.

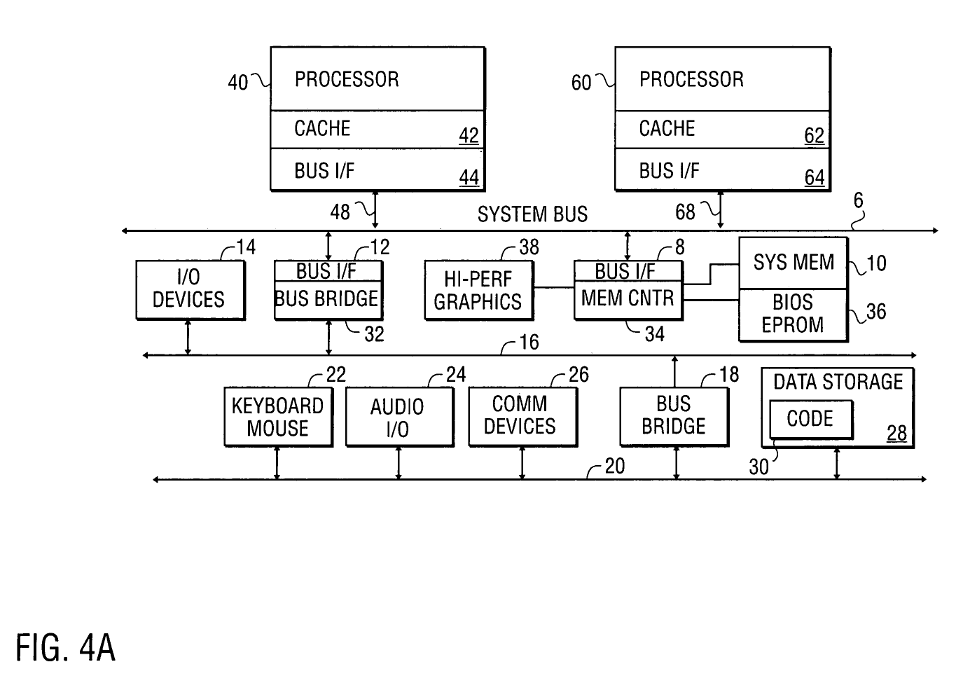

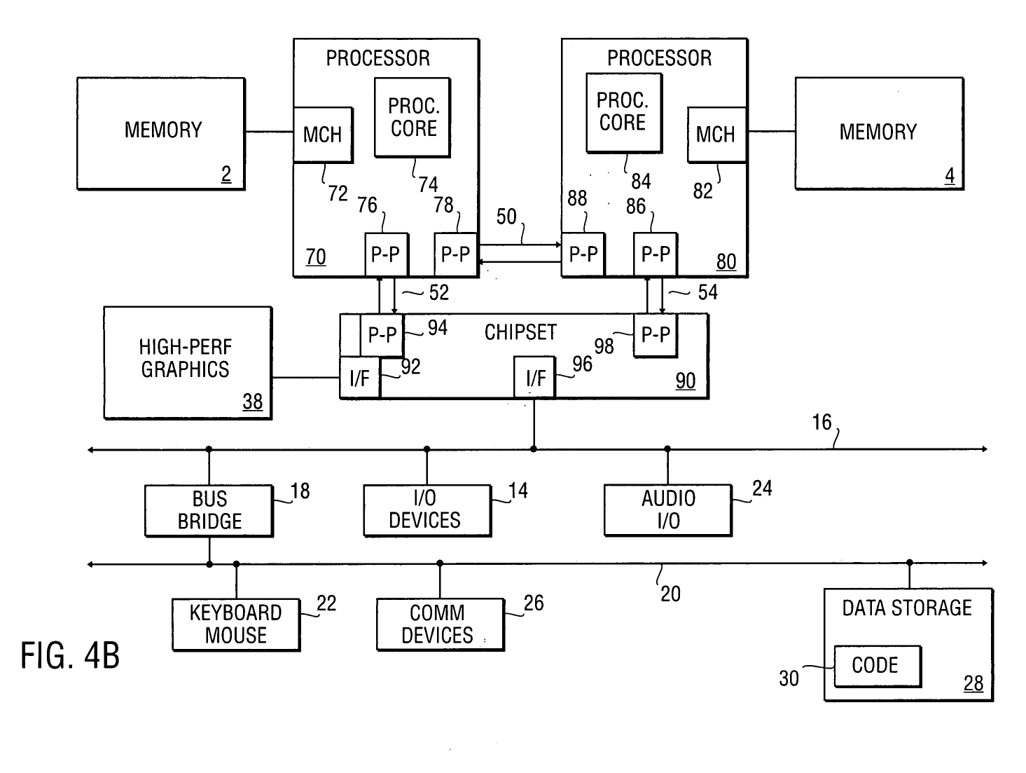

Referring now to FIGS. 4A and 4B, schematic diagrams of microprocessor systems are shown, according to two embodiments of the present disclosure. The FIG. 4A system generally shows a system where processors, memory, and input/output devices are interconnected by a system bus, whereas the FIG. 4B system generally shows a system were processors, memory, and input/output devices are interconnected by a number of point-to-point interfaces.

The FIG. 4A system may include several processors, of which only two, processors 40, 60 are shown for clarity. Processors 40, 60 may include level one caches 42, 62. The FIG. 4A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other busses may be use. In some embodiments memory controller 34 and bus bridge 32 may collectively be referred to as a chipset. In some embodiments, functions of a chipset may be divided among physical chips differently than as shown in the FIG. 4A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct read data from system memory 10 to the high-performance graphics circuit 38 across high-performance graphics interface 39.

The FIG. 4B system may also include several processors, of which only two, processors 70, 80 are shown for clarity. Processors 70, 80 may each include a local memory channel hub (MCH) 72, 82 to connect with memory 2, 4. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 4A system, bus bridge 32 may permit data exchanges between system bus 6 and bus 16, which may in some embodiments be a industry standard architecture (ISA) bus or a peripheral component interconnect (PCI) bus. In the FIG. 4B system, chipset 90 may exchange data with a bus 16 via a bus interface 96. In either system, there may be various input/output I/0 devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
decoding a first instruction into a second instruction and a move instruction;
renaming both a first destination register of said second instruction and a second destination register of said move instruction to a physical register; and
retiring either said second instruction or said move instruction responsive to a predicate value.

2. The method of claim 1, wherein said move instruction is responsive to a complement of said predicate value.

3. The method of claim 1, wherein said decoding includes sending a hint to a register renaming circuit.

4. The method of claim 3, wherein said sending includes sending said hint via a trace cache.

5. The method of claim 1, further comprising sequencing said second instruction and said move instruction for out-of-order execution.

6. The method of claim 5, further comprising, when said second instruction executes before said move instruction and said predicate value is true, squashing said move instruction.

7. The method of claim 6, wherein said squashing occurs before said move instruction executes.

8. The method of claim 5, further comprising, when said move instruction executes before said second instruction and said predicate value is false, squashing said second instruction.

9. The method of claim 8, wherein said squashing occurs before said second instruction executes.

10. A processor, comprising:
a decode circuit to decode a first instruction into a second instruction and a move instruction;
a register renaming circuit to map a first destination register of said second instruction to a physical register, and to map a second destination register of said move instruction to said physical register; and
a retirement circuit to update said physical register with a result of either said second instruction or said move instruction responsive to a predicate value.

11. The processor of claim 10, wherein said move instruction is responsive to a complement of said predicate value.

12. The processor of claim 10, wherein said decode circuit sends a hint to said register renaming circuit to permit said map of said first destination register and said second destination register to said physical register.

13. The processor of claim 12, wherein said hint is sent via a trace cache.

14. The processor of claim 10, further comprising a sequencer to permit out-of-order execution of said second instruction and said move instruction.

15. The processor of claim 14, wherein said retirement circuit may squash said move instruction when said second instruction executes before said move instruction and said predicate value is true.

16. The processor of claim 14, wherein said retirement circuit may squash said second instruction when said move instruction executes before said second instruction and said predicate value is false.

17. The processor of claim 14, further comprising execution units to execute said second instruction and said move instruction in parallel.

18. A processor, comprising:
means for decoding a first instruction into a second instruction and a move instruction;
means for renaming both a first destination register of said second instruction and a second destination register of said move instruction to a physical register; and
means for retiring either said second instruction or said move instruction responsive to a predicate value.

19. The processor of claim 18, wherein said move instruction is responsive to a complement of said predicate value.

20. The processor of claim 18, wherein said means for decoding includes means for sending a hint to a register renaming circuit.

21. The processor of claim 18, further comprising means for sequencing said second instruction and said move instruction for out-of-order execution.

22. The processor of claim 21, further comprising means for squashing said move instruction when said second instruction executes before said move instruction and said predicate value is true.

23. The processor of claim 21, further comprising means for squashing said second instruction when said move instruction executes before said second instruction and said predicate value is false.

24. A system, comprising:
a processor, including a decode circuit to decode a first instruction into a second instruction and a move instruction, a register renaming circuit to map a first destination register of said second instruction to a physical register, and to map a second destination register of said move instruction to said physical register, and a retirement circuit to update said physical register with a result of either said second instruction or said move instruction responsive to a predicate value;
a bus to couple said processor to input/output devices; and
a communications device coupled to said bus.

25. The system of claim 24, wherein said move instruction is responsive to a complement of said predicate value.

26. The system of claim 24, wherein said decode circuit sends a hint to said register renaming circuit to permit said map of said first destination register and said second destination register to said physical register.

27. The system of claim 24, further comprising a sequencer to permit out-of-order execution of said second instruction and said move instruction.

28. The system of claim 27, wherein said retirement circuit may squash said move instruction when said second instruction executes before said move instruction and said predicate value is true.

29. The system of claim 27, wherein said retirement circuit may squash said second instruction when said move instruction executes before said second instruction and said predicate value is false.
